(19) United States
(12) Patent Application Publication
(10) Pub. No.: US 2026/0185831 A1
(43) Pub. Date: Jul. 2, 2026

(54) DEVICE AND METHOD FOR GENERATING NON-TERRESTRIAL COMMUNICATION SYSTEM MODEL

(71) Applicant: ELECTRONICS AND TELECOMMUNICATIONS RESEARCH INSTITUTE, Daejeon (KR)

(72) Inventor: Cheol Ho SHIN, Daejeon (KR)

(21) Appl. No.: 19/358,780

(22) Filed: Oct. 15, 2025

(30) Foreign Application Priority Data
Dec. 26, 2024 (KR) 10-2024-0197712

(51) Int. Cl. G01C 21/20

(52) U.S. Cl. CPC G01C 21/20

(57) ABSTRACT

Provided are a device and method for generating a non-terrestrial communication system model. The method includes setting, by a processor, reference coordinates and a management range of a base station, receiving, by the processor, coordinates of at least one point among a start point, at least one bending point, and an end point of a route and setting a mobile station travel route in accordance with the management range of the base station, determining, by the processor, route distances of mobile stations which will be arranged on the mobile station travel route on the basis of a mobile station arrangement type and a number of mobile stations to be arranged, and calculating, by the processor, arrangement coordinates of the mobile stations.

### CROSS-REFERENCE TO RELATED APPLICATION

This application claims priority to and the benefit of Korean Patent Application No. 10-2024-0197712, filed on Dec. 26, 2024, the disclosure of which is incorporated herein by reference in its entirety.

### BACKGROUND

### 1. Field of the Invention

The present invention relates to a device and method for generating a non-terrestrial communication system model with a route.

### 2. Discussion of Related Art

To analyze the degree of radio interference between different types of wireless communication systems, a minimum coupling loss (MCL) method and a Monte Carlo (MC) method are mainly used.

The MCL method determines the degree of isolation required for multiple wireless communication systems to operate without mutual interference and an isolation distance and an isolation frequency based on the degree of isolation. Subsequently, interference between wireless communication systems can be prevented by separating the distance between a receiver affected by interference and an interfering transmitter or frequencies thereof.

The MC method is a method of determining the possibility of interference statistically after setting all parameter values related to an interference environment. Although this is somewhat complex and the possibility of interference varies depending on input parameter values, it is possible to determine the possibility of interference that reflects an actual environment and simulate all interference environments.

Meanwhile, services such as urban air mobility (UAM), which have emerged as a new means of solving ground traffic congestion in metropolitan areas, provide flights along dedicated routes (corridors) rather than random distribution models and set an altitude range for each route from an origin to a destination.

However, in the MC method which may reflect various environmental conditions for realistic radio interference analysis, the locations of mobile stations and base stations are fixed, or a random distribution model based on a probability function is used.

The background art of the present invention is disclosed in Korean Patent Application Publication No. 10-2004-0085942 (filed on Oct. 8, 2004).

### SUMMARY OF THE INVENTION

The present invention is directed to providing a device and method for generating a non-terrestrial communication system model that make it possible to design and implement a non-terrestrial wireless communication system model with a determined route (corridor), such as urban air mobility (UAM), suitable for a Monte Carlo (MC) simulation.

According to an aspect of the present invention, there is provided a method of generating a non-terrestrial communication system model, the method including setting, by a processor, reference coordinates and a management range of a base station, receiving, by the processor, coordinates of at least one point among a start point, at least one bending point, and an end point of a route and setting a mobile station travel route in accordance with the management range of the base station, determining, by the processor, route distances of mobile stations which will be arranged on the mobile station travel route on the basis of a mobile station arrangement type and a number of mobile stations to be arranged, and calculating, by the processor, arrangement coordinates of the mobile stations.

The management range of the base station may be one of a one-way route and a roundtrip route.

The setting of the mobile station travel route may include acquiring, by the processor, new coordinates between the points on the mobile station travel route, calculating a cumulative route distance using the coordinates on the mobile station travel route, and calculating a total route distance from the start point to the end point using the cumulative route distance.

The setting of the mobile station travel route may include acquiring, by the processor, the new coordinates between the points on the mobile station travel route using at least one of interpolation and a coordinate setting technique.

The determining of the route distances of the mobile stations which will be arranged may include receiving, by the processor, the mobile station arrangement type and the number of mobile stations to be arranged from a user.

The determining of the route distances of the mobile stations which will be arranged may include, when the mobile station arrangement type is random, randomly selecting, by the processor, as many route distances at which the mobile stations will be arranged as the number of mobile stations to be arranged within a range not exceeding a total route distance of the mobile station travel route.

The determining of the route distances of the mobile stations which will be arranged may include, when the mobile station arrangement type is equal, calculating, by the processor, a mobile station arrangement interval using the total route distance of the mobile station travel route and the number of mobile stations to be arranged, evenly dividing the mobile station travel route at the mobile station arrangement intervals, setting a route distance at which a first mobile station will be placed within a range not exceeding the mobile station arrangement interval, and selecting as many route distances at which the mobile stations will be arranged as the number of mobile stations to be arranged while adding the mobile station arrangement intervals to the route distance of the first mobile station.

The calculating of the arrangement coordinates of the mobile stations may include calculating, by the processor, the arrangement coordinates of the mobile stations using route distances of the mobile stations which will be arranged on the mobile station travel route.

According to another aspect of the present invention, there is provided a device for generating a non-terrestrial communication system model, the device including a memory, an input module, and a processor connected to the memory and the input module. The processor receives coordinates of at least one point among a start point, at least one bending point, and an end point of a route through the input module, sets a mobile station travel route in accordance with a management range of a base station, determines route distances of mobile stations which will be arranged on the mobile station travel route on the basis of a mobile station arrangement type and a number of mobile stations to be arranged, and calculates arrangement coordinates of the mobile stations to generate a non-terrestrial communication system model.

The processor may set reference coordinates of the base station which is a reference point of the non-terrestrial communication system model.

The management range of the base station may be one of a one-way route and a roundtrip route.

When setting the mobile station travel route, the processor may acquire new coordinates between the points on the mobile station travel route, calculate a cumulative route distance using the coordinates on the mobile station travel route, and calculate a total route distance from the start point to the end point using the cumulative route distance.

The processor may acquire the new coordinates between the points on the mobile station travel route using at least one of interpolation and a coordinate setting technique.

The processor may receive the mobile station arrangement type and the number of mobile stations to be arranged from a user through the input module.

When the mobile station arrangement type is random, the processor may randomly select as many route distances at which the mobile stations will be arranged as the number of mobile stations to be arranged within a range not exceeding a total route distance of the mobile station travel route.

When the mobile station arrangement type is equal, the processor may calculate a mobile station arrangement interval using the total route distance of the mobile station travel route and the number of mobile stations to be arranged, evenly divide the mobile station travel route at the mobile station arrangement intervals, set a route distance at which a first mobile station will be placed within a range not exceeding the mobile station arrangement interval, and select as many route distances at which the mobile stations will be arranged as the number of mobile stations to be arranged while adding the mobile station arrangement intervals to the route distance of the first mobile station.

The processor may calculate the arrangement coordinates of the mobile stations using route distances of the mobile stations which will be arranged on the mobile station travel route.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is a diagram illustrating communication between a mobile station and a terrestrial system;

FIG. 2 is a block diagram schematically showing a configuration of a device for generating a non-terrestrial communication system model according to an exemplary embodiment of the present invention;

FIG. 3 is a flowchart illustrating a method of generating a non-terrestrial communication system model according to an exemplary embodiment of the present invention;

FIG. 4A is an example view illustrating pointing of a base station direction of a non-terrestrial communication system model according to an exemplary embodiment of the present invention;

FIG. 4B is an example view illustrating pointing of a route direction of a non-terrestrial communication system model according to an exemplary embodiment of the present invention;

FIG. 5 is an example view illustrating reference coordinates of a base station according to an exemplary embodiment of the present invention;

FIG. 6A is an example view illustrating a one-way route managed by a base station according to an exemplary embodiment of the present invention;

FIG. 6B is an example view illustrating a roundtrip route managed by a base station according to an exemplary embodiment of the present invention;

FIG. 7 is an example diagram illustrating a method of calculating coordinates at which mobile stations are arranged according to an exemplary embodiment of the present invention;

FIG. 8 is a flowchart illustrating a method of setting a mobile station travel route according to an exemplary embodiment of the present invention;

FIG. 9 is an example diagram illustrating setting of a mobile station travel route according to an exemplary embodiment of the present invention;

FIG. 10 is an example diagram illustrating setting of new coordinates using interpolation according to an exemplary embodiment of the present invention;

FIG. 11 is an example diagram illustrating a cumulative route distance between coordinates according to an exemplary embodiment of the present invention;

FIG. 12 is a flowchart illustrating a method of randomly arranging mobile stations according to an exemplary embodiment of the present invention;

FIG. 13 is an example diagram in which five mobile stations are randomly arranged on a mobile station travel route according to an exemplary embodiment of the present invention;

FIG. 14 is a flowchart illustrating a method of evenly arranging mobile stations according to an exemplary embodiment of the present invention; and

FIGS. 15A to 15C are example diagrams in which five mobile stations are evenly arranged on a mobile station travel route according to an exemplary embodiment of the present invention.

### DETAILED DESCRIPTION OF EXEMPLARY EMBODIMENTS

Hereinafter, a device and method for generating a non-terrestrial communication system model according to exemplary embodiments of the present invention will be described with reference to the accompanying drawings. In this process, the thicknesses of lines, the sizes of components, etc., shown in the drawings may be exaggerated for the purpose of clarity and convenience of description. Moreover, terms used herein are defined in consideration of functions in the present invention, and the terms may vary depending on the intention of a user or operator or precedents thereof. Therefore, these terms are to be defined on the basis of the overall content of the specification.

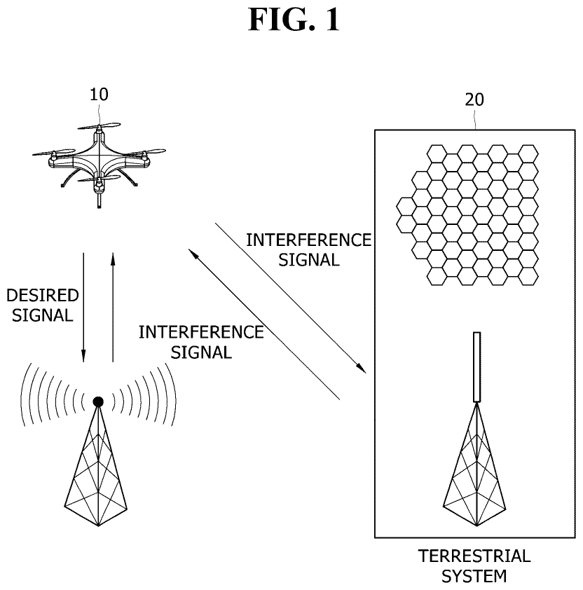

FIG. 1 is a diagram illustrating communication between a mobile station and a terrestrial system.

Referring to FIG. 1, a mobile station 10 is a means of transportation that may fly in the air, and representative examples thereof may be an urban air mobility (UAM) aircraft, a drone, etc., which are used for various purposes. In this exemplary embodiment, a route along which the mobile station (UAM) 10 travels is assumed to be a predetermined specific route.

A terrestrial system 20 is fixedly installed in a distributed manner at different locations on the ground around a specific flight route and may be a mobile communication base station, a satellite base station, a radar, and the like.

When the mobile station 10 transmits a signal to communicate with the terrestrial system 20, the transmitted signal may operate as an interference signal for the terrestrial system 20 that is providing service in the same band as a frequency band of the mobile station 10 or in a band adjacent thereto.

Also, when the mobile station 10 receives a desired magnetic signal, a signal transmitted by the terrestrial system 20 that is providing service in the same or adjacent band may operate as an interference signal for the mobile station 10.

Accordingly, the present invention proposes technology for generating a non-terrestrial wireless communication service model that satisfies requirements of a non-terrestrial service, such as UAM, with a determined route, copes with expansion and changes of a route structure and an operational form which may be caused by service vitalization in the future, and has a route for handling traffic changes caused by an increase in operation. A non-terrestrial communication system model may be a model that describes a communication system using a base station on Earth and a non-terrestrial platform such as a satellite, a drone, or another aircraft.

For convenience of description, a base station is assumed to be located on the ground, and plane coordinates (X, Y) and an antenna height z will be used. In the case of the mobile station 10, a Z coordinate corresponding to a flight altitude will be used together with plane coordinates (X, Y). When a non-terrestrial communication system model with a route proposed in the present invention is applied to a situation in which actual geographical features are taken into consideration, latitude and longitude coordinates and a flight altitude coordinate may be used.

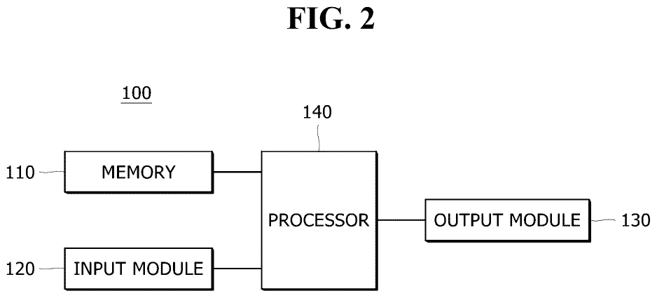

FIG. 2 is a block diagram schematically showing a configuration of a device for generating a non-terrestrial communication system model according to an exemplary embodiment of the present invention.

Referring to FIG. 2, a device 100 for generating a non-terrestrial communication system model according to the exemplary embodiment of the present invention may include a memory 110, an input module 120, an output module 130, and a processor 140.

The memory 110 may be a component that stores data related to operations of the device 100 for generating a non-terrestrial communication system model. In particular, the memory 110 may store a program (application or applet) for receiving coordinates of at least one point among a start point, at least one bending point, and an end point of a route and setting a mobile station travel route, a program (application or applet) for determining route distances of mobile stations 10 which will be arranged on a mobile station travel route on the basis of a mobile station arrangement type and the number of mobile stations to be arranged and calculating arrangement coordinates of the mobile stations 10 to generate a non-terrestrial communication system model, etc., and the stored information may be selected by the processor 140 as necessary. Also, the memory 110 may store a variety of kinds of data generated during a process of executing an operating system (OS) or a program (application or applet) for operating the device 100 for generating a non-terrestrial communication system model. Here, the memory 110 collectively refers to non-volatile storage devices that continue to maintain stored information even without power supply, and volatile storage devices that require power for maintaining stored information. In addition, the memory 110 may function to store data processed by the processor 140 temporarily or permanently. Here, the memory 110 may include magnetic storage media or flash storage media in addition to volatile storage devices, but the scope of the present invention is not limited thereto.

The input module 120 is provided to receive user instructions, etc., and may receive data or a control instruction required for generating a non-terrestrial communication system model and transmit the data or control instruction to the processor 140. For example, the input module 120 may receive coordinates of at least one point among the start point, the at least one bending point, and the end point of the route, a setting of a mobile station arrangement type (random or equal), a base station management range (a one-way route or a roundtrip route), the number of mobile stations to be arranged, etc., from a user and transmit the received information to the processor 140. The input module 120 may be provided as a user interface such as a keyboard, a mouse, a touchpad, a touchscreen, an electronic pen, a touch button, or the like.

The output module 130 may output a result of generating a non-terrestrial communication system model, etc., under the control of the processor 140. The output module 130 may be implemented as a display, a printer, or the like. Here, the display may be implemented as, for example, a thin film transistor-liquid crystal display (TFT-LCD) panel, a light-emitting diode (LED) panel, an organic LED (OLED) panel, an active matrix OLED (AMOLED) panel, a flexible panel, or the like.

Meanwhile, in the exemplary embodiment of the present invention, the input module 120 and the output module 130 are described as separate components. However, the input module 120 and the output module 130 may be implemented as one component such as a touchpad, a touchscreen, or the like.

The processor 140 may be configured to control overall operations of the device 100 for generating a non-terrestrial communication system model. For example, the processor 140 may execute software (e.g., a program) stored in the memory 110 to control a component (e.g., at least one of the memory 110, the input module 120, and the output module 130) connected to the processor 140. The processor 140 may be implemented as, but is not limited to, an application specific integrated circuit (ASIC), a digital signal processor (DSP), a programmable logic device (PLD), a field programmable gate array (FPGA), a central processing unit (CPU), a microcontroller, a microprocessor, and/or the like.

The processor 140 may receive the coordinates of the at least one point among the start point, the at least one bending point, and the end point of the route, set a mobile station travel route in accordance with a management range of a base station, determine route distances of the mobile stations 10 which will be arranged on the mobile station travel route on the basis of a mobile station arrangement type and the number of mobile stations to be arranged, and calculate arrangement coordinates of the mobile stations 10, thereby generating a non-terrestrial communication system model.

A method in which the processor 140 generates a non-terrestrial communication system model will be described in detail below.

When a non-terrestrial communication system model generation program is executed, the processor 140 may receive a communication system model type selected by the user.

In other words, for a Monte Carlo (MC) simulation, it is necessary to select whether the communication system model is a downlink system or an uplink system. Accordingly, the processor 140 may receive a selected communication system model type of a downlink system or an uplink system. When a downlink system is selected, a transmitter may be the base station, and a receiver may be a mobile station. When an uplink system is selected, a transmitter may be a mobile station, and a receiver may be the base station. When a communication system model type is selected, the processor 140 may select parameters in accordance with characteristics of the communication system model.

Since a non-terrestrial communication system model with a route has a flight route in the air, pointing of a base station direction of a terrestrial communication system model and pointing of a route direction from an antenna point may be added.

When a communication system model is selected, the processor 140 may perform a process of determining locations of base stations and mobile stations of a non-terrestrial communication system.

First, the processor 140 may set reference coordinates of the base station which correspond to a reference point of the non-terrestrial communication system model with a route.

For example, the processor 140 may set, as a reference point, a base station having an X coordinate of 0 and a Y coordinate of 0, that is, (0, 0), and an antenna height of 20 m.

When the reference coordinates of the base station are set, the processor 140 may set a base station management range. Here, the base station management range refers to a shape of a mobile station route and may include, for example, a one-way route and a roundtrip route.

The non-terrestrial communication system model with a route may have two routes, forward and reverse routes, and it may be selected whether to manage mobile stations corresponding to the reverse route and mobile stations corresponding to the forward route using separate base stations (one-way route) or manage all the mobile stations 10 located on both the forward and reverse routes using one base station (roundtrip route).

For convenience of description, a one-way route for managing mobile stations 10 located on one route using one base station will be mainly described below.

When the base station management range is set, the processor 140 may set a mobile station travel route. When coordinates of at least one point among a start point, at least one bending point, and an end point of the route are input through the input module 120, the processor 140 may set a mobile station travel route in accordance with the base station management range. Here, the processor 140 may acquire new coordinates between the points on the mobile station travel route using at least one of interpolation and a coordinate setting technique. Also, the processor 140 may calculate a cumulative route distance using coordinates on the mobile station travel route and calculate a total route distance from the start point to the end point using the cumulative route distance.

When the mobile station travel route is set, the processor 140 may determine route distances of the mobile stations 10 which will be arranged on the mobile station travel route on the basis of a mobile station arrangement type and the number of mobile stations to be arranged. Here, the mobile station arrangement type and the number of mobile stations to be arranged may be input through the input module 120. The mobile station arrangement type may include random and equal.

When the mobile station arrangement type is random, the processor 140 may randomly select as many route distances at which the mobile stations 10 will be arranged as the number of mobile stations to be arranged within a range not exceeding the total route distance of the mobile station travel route.

When the mobile station arrangement type is equal, the processor 140 may calculate a mobile station arrangement interval using the total route distance of the mobile station travel route and the number of mobile stations to be arranged and evenly divide the mobile station travel route at the mobile station arrangement intervals. Subsequently, the processor 140 may set a route distance at which a first mobile station will be placed within a range not exceeding the mobile station arrangement interval and determine as many route distances at which the mobile stations will be arranged as the number of mobile stations to be arranged while adding the mobile station arrangement intervals to the route distance of the first mobile station.

When the route distances of the mobile stations 10 which will be arranged in the mobile station travel route are determined, the processor 140 may calculate arrangement coordinates of the mobile stations 10. Here, the processor 140 may calculate the arrangement coordinates of the mobile stations 10 using the route distances of the mobile stations 10 which will be arranged on the mobile station travel route.

The device 100 for generating a non-terrestrial communication system model according to the present invention can propose a design and implementation method for generating a non-terrestrial wireless communication system model with a route that can provide a scheme for setting a flexible mobile station route (a start point, bending points, and an end point) that is applicable to MC simulations, a scheme for setting mobile station arrangement types (random and equal), a scheme for setting a base station management range (a one-way route or a roundtrip route), and a scheme for setting various traffic environments.

To analyze radio wave interference in advance due to introduction of a non-terrestrial service with a determined route such as UAM, the present invention proposes a scheme for designing and implementing a non-terrestrial wireless communication system model that can provide a scheme for setting a flexible mobile station route (a start point, bending points, and an end point) that is applicable to MC simulations, a scheme for setting mobile station arrangement types (random and equal), a scheme for setting a base station management range (a one-way route or a roundtrip route), and a scheme for setting various traffic environments, thus supporting setting of an optimal base station location and a travel route, which contributes to solving traffic congestion in metropolitan areas and vitalizing new services.

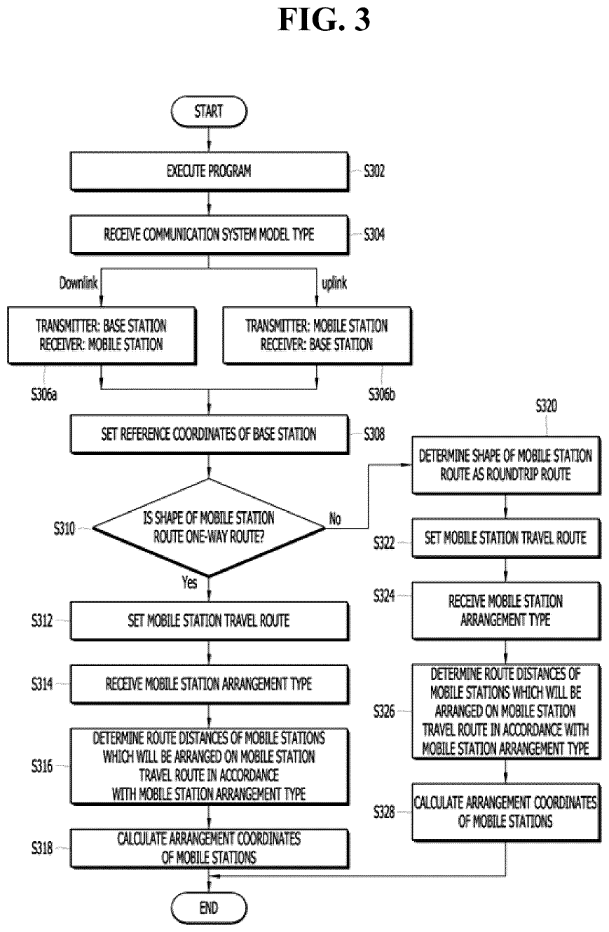

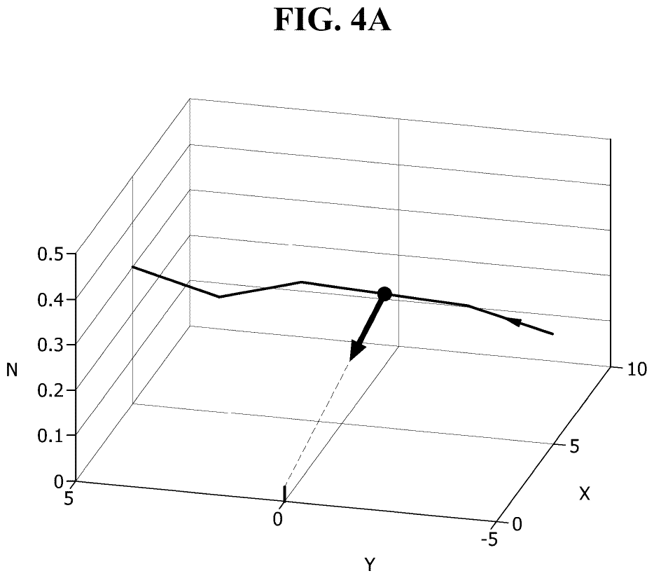

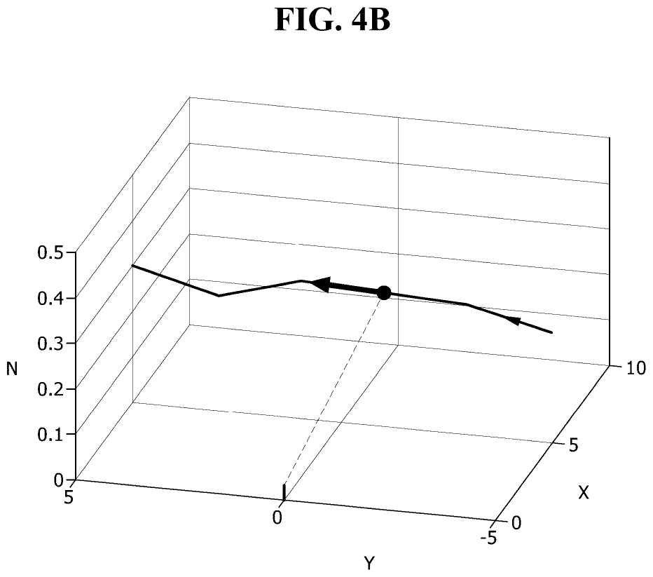

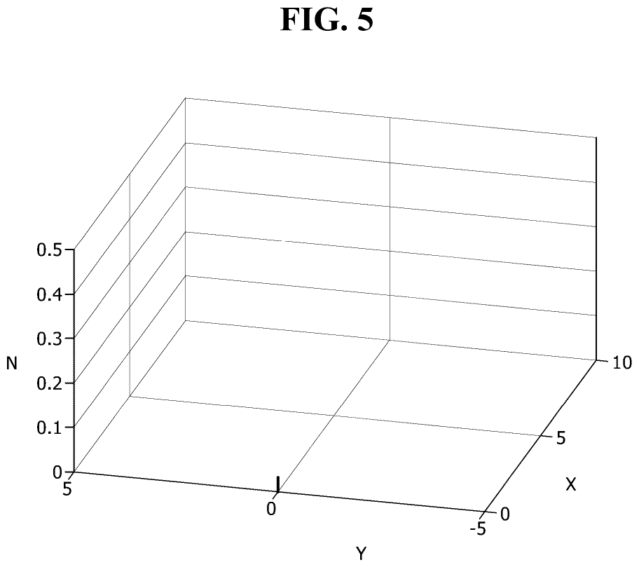

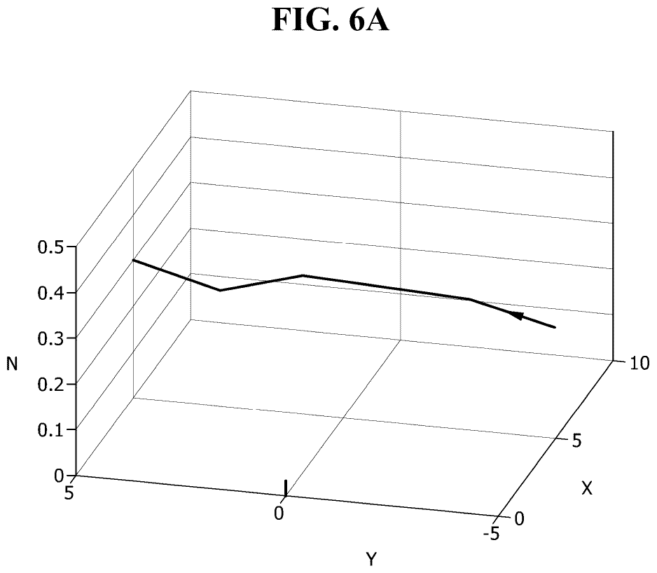

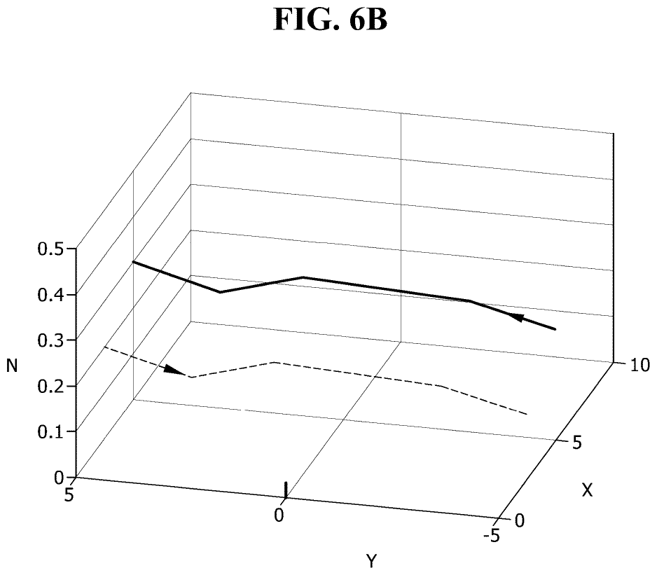

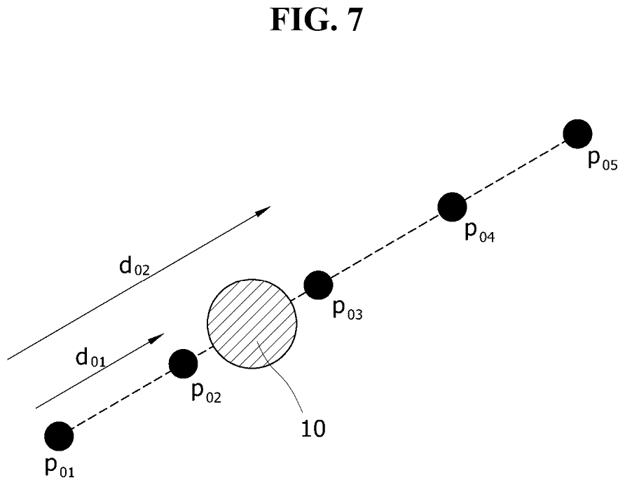

FIG. 3 is a flowchart illustrating a method of generating a non-terrestrial communication system model according to an exemplary embodiment of the present invention. FIG. 4A is an example view illustrating pointing of a base station direction of a non-terrestrial communication system model according to an exemplary embodiment of the present invention. FIG. 4B is an example view illustrating pointing of a route direction of a non-terrestrial communication system model according to an exemplary embodiment of the present invention. FIG. 5 is an example view illustrating reference coordinates of a base station according to an exemplary embodiment of the present invention. FIG. 6A is an example view illustrating a one-way route managed by a base station according to an exemplary embodiment of the present invention. FIG. 6B is an example view illustrating a roundtrip route managed by a base station according to an exemplary embodiment of the present invention. FIG. 7 is an example diagram illustrating a method of calculating coordinates at which mobile stations are arranged according to an exemplary embodiment of the present invention.

Referring to FIG. 3, when the non-terrestrial communication system model generation program is executed (S302), the processor 140 receives a communication system model type selected by a user (S304). In other words, the processor 140 may receive information about whether the user has selected a downlink system or an uplink system.

When a downlink system has been selected in operation S304, the processor determines parameters in accordance with a situation in which a transmitter is a base station and a receiver is a mobile station 10 (S306A).

When an uplink system has been selected in operation S304, the processor determines parameters in accordance with a situation in which a transmitter is a mobile station 10 and a receiver is a base station (S306B).

Since a non-terrestrial communication system model with a route has a flight route in the air, the processor 140 may add the antenna reference pointing of a base station direction of a terrestrial communication system model as shown in FIG. 4A and the antenna reference pointing of a route direction from an antenna point as shown in FIG. 4B.

When operations S306A and S306B are performed, the processor 140 sets reference coordinates of a base station that correspond to a reference point of the non-terrestrial communication system model with a route (S308).

For example, as shown in FIG. 5, the processor 140 may set a base station having an X coordinate of 0 and a Y coordinate of 0, that is, (0, 0), and an antenna height of 20 m as a reference point.

When operation S308 is performed, the processor 140 determines whether a shape of a mobile station route is a one-way route (S310). Here, shapes of the mobile station route may include a one-way route and a roundtrip route.

The non-terrestrial communication system model with a route may have 2 routes, forward and reverse routes, and it may be selected whether to manage mobile stations 10 corresponding to the reverse route and mobile stations 10 corresponding to the forward route using separate base stations (a one-way route) or manage all the mobile stations 10 located on both the forward and reverse routes using one base station (a roundtrip route). The non-terrestrial communication system model with a route has a one-way route as shown in FIG. 6A and a roundtrip route as shown in FIG. 6B.

When it is determined in operation S310 that the shape of the mobile station route is a one-way route, the processor 140 sets a mobile station travel route (S312). When a start point, at least one bending point, and an end point of a route along which the mobile stations 10 actually travel are input, the processor 140 may set a mobile station travel route in accordance with the base station management range. Here, the bending point may be multiple points such that the mobile station travel route may be similar to an actual mobile station route.

The processor 140 may acquire new coordinates between the points on the mobile station travel route, calculate a cumulative route distance using the coordinates on the mobile station travel route, and calculate a total route distance from the start point to the end point using the cumulative route distance. Here, the processor 140 may acquire the new coordinates between the points in the mobile station travel route using at least one of interpolation and a coordinate setting technique.

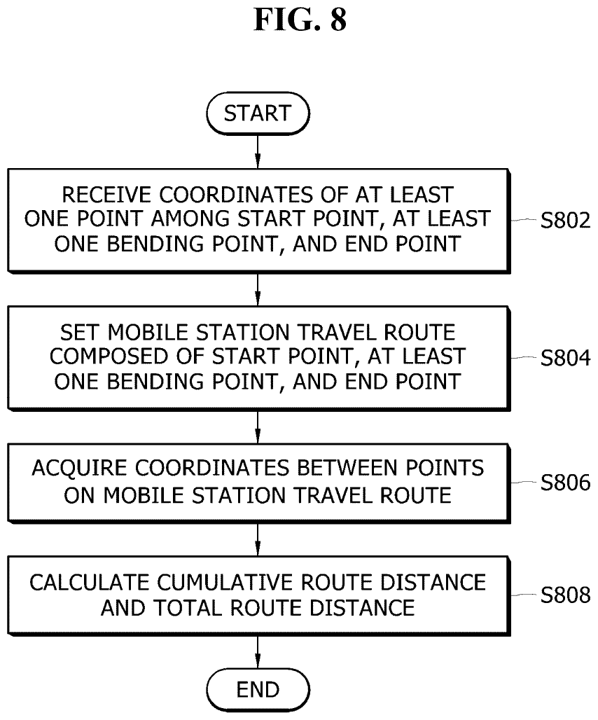

Detailed description of how the processor 140 sets the mobile station travel route will be given with reference to FIG. 8.

When operation S312 is performed, the processor 140 receives an input of a mobile station arrangement type (S314). Here, the mobile station arrangement type may be random or equal.

When operation S314 is performed, the processor 140 determines route distances of the mobile stations 10 which will be arranged on the mobile station travel route on the basis of the number of mobile stations in accordance with the mobile station arrangement type (S316).

When the mobile station arrangement type is random, the processor 140 may randomly select as many route distances at which the mobile stations 10 will be arranged as the number of mobile stations to be arranged within a range not exceeding the total route distance of the mobile station travel route.

When the mobile station arrangement type is equal, the processor 140 may calculate a mobile station arrangement interval using the total route distance of the mobile station travel route and the number of mobile stations to be arranged and evenly divide the mobile station travel route at the mobile station arrangement intervals. Subsequently, the processor 140 may set a route distance at which a first mobile station 10 will be placed within a range not exceeding the mobile station arrangement interval and determine as many route distances at which the mobile stations 10 will be arranged as the number of mobile stations to be arranged while adding the mobile station arrangement intervals to the route distance of the first mobile station.

When operation S316 is performed, the processor 140 calculates arrangement coordinates of the mobile stations 10 which will be arranged on the mobile station travel route using the route distances of the mobile stations 10 (S318).

For example, a method of acquiring arrangement coordinates of a mobile station 10 when the mobile station 10 is placed as shown in FIG. 7 will be described. The mobile station 10 is located between p₀₂(X₀₂, Y₀₂, Z₀₂) and p₀₃(X₀₃, Y₀₃, Z₀₃). When a cumulative distance from p₀₁, which is a start point, to p₀₂ is d₀₁ and a cumulative distance from p₀₁ to pos is d₀₂, arrangement coordinates pₘ₁ (Xₘ₁, Yₘ₁, Zₘ₁) of the mobile station 10 may be calculated using Equation 2.

The processor 140 may calculate which ratio between p₀₂ and p₀₃ the mobile station coordinates pₘ₁(Xₘ₁, Yₘ₁, Zₘ₁) correspond to using a route distance dₘ₁ at which the mobile station 10 is located. In other words, the processor 140 may calculate a ratio of the mobile station coordinates using Equation 1 below.

$$ratio = ( {d}_{m 1} - {d}_{01} ) / ( {d}_{02} - {d}_{01} ) \qquad [ Equation 1 ]$$

The processor 140 may acquire the mobile station coordinates pₘ₁(Xₘ₁, Yₘ₁, Zₘ₁) using the ratio calculated on the basis of Equation 1. In other words, the processor 140 may calculate the arrangement coordinates pₘ₁(Xₘ₁, Yₘ₁, Zₘ₁) that the mobile station 10 corresponds to using Equation 2 below.

$${X}_{m 1} = {X}_{02} + ratio * ( {X}_{03} - {X}_{02} ) \qquad [ Equation 2 ]$$

$${Y}_{m 1} = {Y}_{02} + ratio * ( {Y}_{03} - {Y}_{02} )$$

$${Z}_{m 1} = {Z}_{02} + ratio * ( {Z}_{03} - {Z}_{02} )$$

When it is determined in operation S310 that the shape of the mobile station route is not a one-way route, the processor 140 determines the shape of the mobile station route as a roundtrip route (S320) and sets a mobile station travel route for each of a forward route and a reverse route (S322).

When operation S322 is performed, the processor 140 receives an input of a mobile station arrangement type (S324).

When operation S324 is performed, the processor 140 determines route distances of the mobile stations 10 which will be arranged on the mobile station travel route on the basis of the number of mobile stations to be arranged in accordance with the mobile station arrangement type (S326).

When operation S326 is performed, the processor 140 calculates arrangement coordinates of the mobile stations 10 using the route distances of the mobile stations 10 which will be arranged on the mobile station travel route (S328).

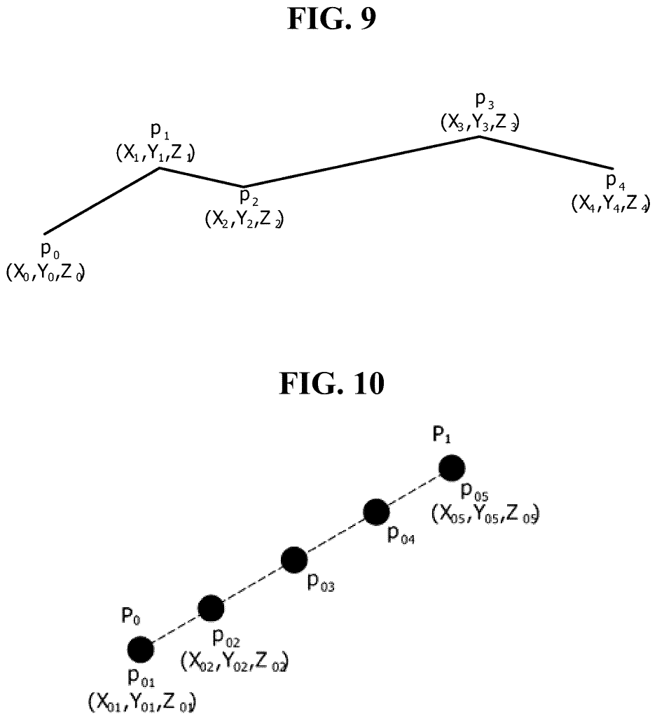

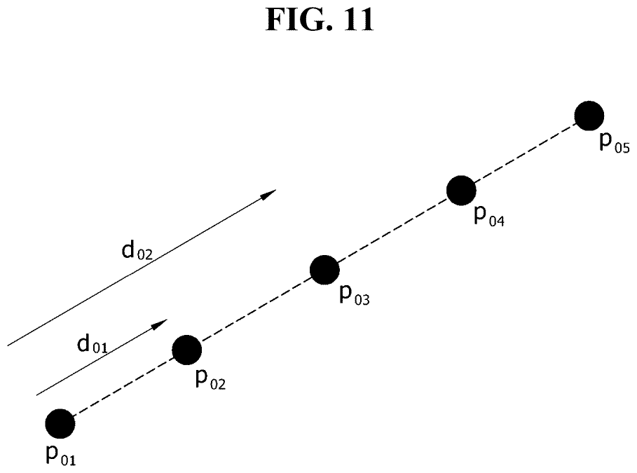

FIG. 8 is a flowchart illustrating a method of setting a mobile station travel route according to an exemplary embodiment of the present invention. FIG. 9 is an example diagram illustrating setting of a mobile station travel route according to an exemplary embodiment of the present invention. FIG. 10 is an example diagram illustrating setting of new coordinates using interpolation according to an exemplary embodiment of the present invention. FIG. 11 is an example diagram illustrating a cumulative route distance between coordinates according to an exemplary embodiment of the present invention.

Referring to FIG. 8, when coordinates of at least one point among a start point, at least one bending point, and an end point of a route are input by a user (S802), the processor 140 sets a mobile station travel route composed of the start point, the at least one bending point, and the end point (S804). A route along which a mobile station 10 may travel may be set using a start point, a bending point, and an end point, and the bending point may be multiple points such that the route may be similar to an actual mobile station route. Therefore, the processor 140 may receive the coordinates of the start point, the at least one bending point, and the end point to set the mobile station travel route.

For example, as shown in FIG. 9, the processor 140 may set a mobile station travel route having a start point P₀, bending points P₁, P₁, and P₃ and an end point P₄.

When operation S804 is performed, the processor 140 acquires coordinates between points in the mobile station travel route (S806). Here, the processor 140 may acquire new coordinates between the points in the mobile station travel route using at least one of interpolation and a coordinate setting technique.

For example, new coordinates P₀₂, P₀₃, and P₀₄ interpolated from P₀ and P₁ of FIG. 9 are acquired as shown in FIG. 10. In FIG. 10, P₀₁(X₀₁, Y₀₁, Z₀₁) is the same as P₀(X₀, Y₀, Z₀) of FIG. 9, and P₀₂(X₀₂, Y₀₂, Z₀₂) newly generated through interpolation may be calculated using Equation 3 below.

$${X}_{02} = {X}_{01} + Δ x \qquad [ Equation 3 ]$$

$${Y}_{02} = {Y}_{01} + Δ y$$

$${Z}_{02} = {Z}_{01} + Δ z$$

Here, Δx, Δy, and Δz may be intervals between coordinates newly generated through interpolation.

The processor 140 may calculate coordinates between the route points from the start point to the end point using interpolation and a coordinate setting technique such as Equation 3.

When operation S806 is performed, the processor 140 calculates a cumulative route distance and a total distance from the start point to the end point (S808). Here, the processor 140 may calculate a distance between two coordinates using the Euclidean distance and add all distances between two coordinates to calculate the total route distance.

For example, in the case of calculating a cumulative route distance using coordinates on the mobile station travel route shown in FIG. 10, the processor 140 may calculate d₀₁ which is a distance between p₀₂(X₀₂, Y₀₂, Z₀₂) and p₀₁(X₀₁, Y₀₁, Z₀₁) shown in FIG. 11 and d₀₂ which is a distance between p₀₃(X₀₃, Y₀₃, Z₀₃) and p₀₁(X₀₁, Y₀₁, Z₀₁) using Equation 4 below.

$${d}_{01} = SQRT [ {( {X}_{02} - {X}_{01} )}^{2} + {( {Y}_{02} - {Y}_{01} )}^{2} + {( {Z}_{02} - {Z}_{01} )}^{2} ] \qquad [ Equation 4 ]$$

$${d}_{02} = {d}_{01} + SQRT [ {( {X}_{03} - {X}_{02} )}^{2} + {( {Y}_{03} - {Y}_{02} )}^{2} + {( {Z}_{03} - {Z}_{02} )}^{2} ]$$

The total route distance from the start point to the end point may be acquired as a total distance from p₀(X₀, Y₀, Z₀) to p₄(X₄, Y₄, Z₄) shown in FIG. 9 using Equation 4.

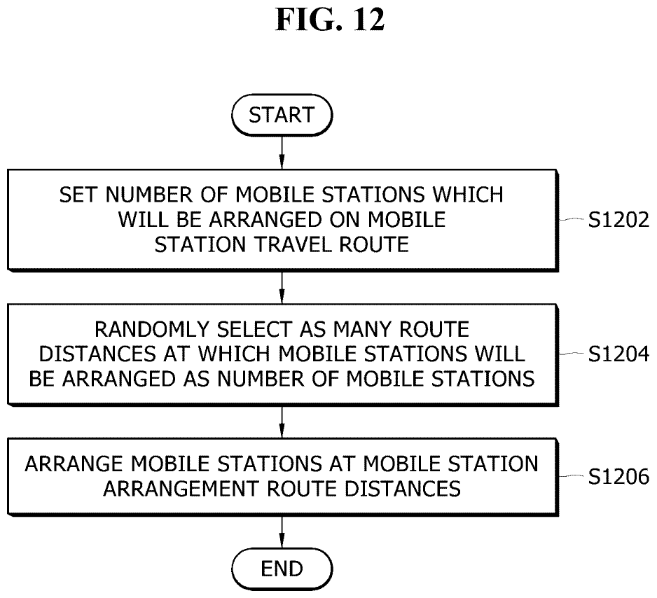

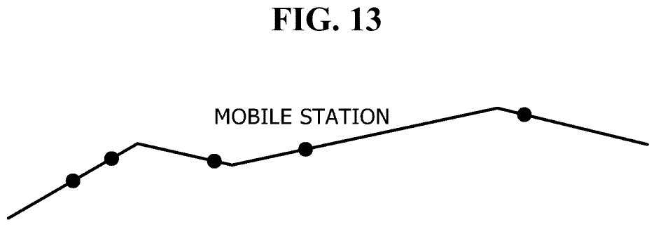

FIG. 12 is a flowchart illustrating a method of randomly arranging mobile stations according to an exemplary embodiment of the present invention, and FIG. 13 is an example diagram in which five mobile stations 10 are randomly arranged on a mobile station travel route according to an exemplary embodiment of the present invention.

Referring to FIG. 12, the processor 140 sets the number of mobile stations 10 which will be arranged on a mobile station travel route (S1202). Here, the processor 140 may receive the number of mobile stations to be arranged from the user or use a preset number of mobile stations to be arranged.

For example, the processor 140 may randomly set the number of mobile stations to be arranged to, for example, 3 to 7 or set the number of mobile stations to be arranged to a fixed number such as 5. The number range of mobile stations 10 and the fixed number of mobile stations 10 are flexibly changeable.

When operation S1202 is performed, the processor 140 randomly selects as many route distances at which the mobile stations 10 will be arranged as the number of mobile stations to be arranged within a range not exceeding the total route distance (S1204) and arranges the mobile stations 10 at the selected mobile station arrangement route distances (S1206).

Here, the processor 140 may sort by distance as many mobile station arrangement route distances that are randomly selected as the number of mobile stations to be arranged.

For example, five mobile stations 10 may be randomly arranged on the mobile station travel route as shown in FIG. 13.

In the case of arranging mobile stations 10 at specific locations on the mobile station travel route, the processor 140 may set as many route distances at which the mobile stations 10 will be arranged as the number of mobile stations to be arranged within a range not exceeding the total route distance.

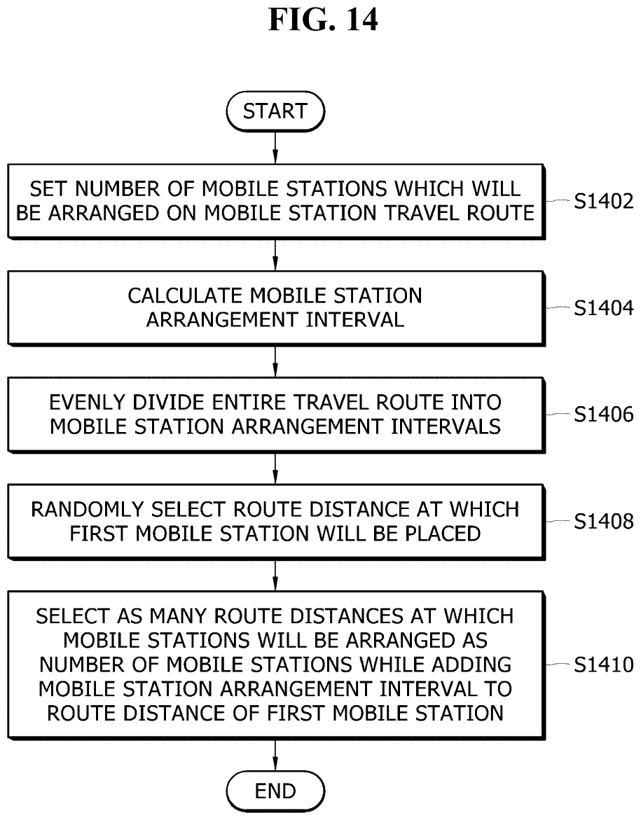

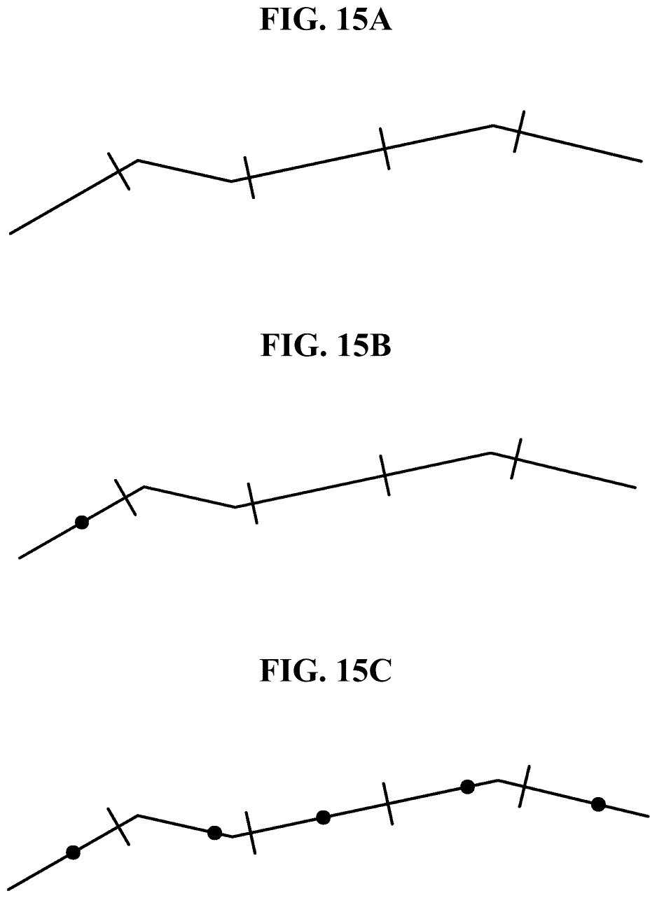

FIG. 14 is a flowchart illustrating a method of evenly arranging mobile stations according to an exemplary embodiment of the present invention, and FIGS. 15A to 15C are example diagrams in which five mobile stations are evenly arranged on a mobile station travel route according to an exemplary embodiment of the present invention.

Referring to FIG. 14, the processor 140 sets the number of mobile stations 10 which will be arranged on a mobile station travel route (S1402). Here, the processor 140 may receive an input of the number of mobile stations to be arranged from the user or use a preset number of mobile stations to be arranged.

For example, the processor 140 may randomly set the number of mobile stations to be arranged to, for example, 3 to 7 or set the number of mobile stations to be arranged to a fixed number such as 5. The number range of mobile stations 10 and the fixed number of mobile stations 10 are flexibly changeable.

When operation S1402 is performed, the processor 140 calculates a mobile station arrangement interval using a total route distance and the number of mobile stations to be arranged (S1404). In other words, the processor 140 may calculate the mobile station arrangement interval using Equation 5 below.

Mobile station arrangement interval=Total route distance/Number of mobile stations to be arranged [Equation 5]

When operation S1404 is performed, the processor 140 evenly divides an entire travel route into the mobile station arrangement intervals (S1406).

When operation S1406 is performed, a route distance at which a first mobile station 10 will be placed is randomly selected within a range not exceeding the mobile station arrangement interval (S1408). In other words, the processor 140 may place the first base station 10 at a random location on an evenly divided first travel route.

When operation S1408 is performed, the processor 140 selects as many route distances at which the mobile stations 10 will be arranged as the number of mobile stations to be arranged while adding the mobile station arrangement intervals to the first mobile station route distance (S1410). In other words, other mobile stations may be arranged at the mobile station arrangement intervals from the first placed first mobile station 10.

For example, the processor 140 may arrange mobile stations 10 using “second mobile station route distance=first mobile station route distance+mobile station arrangement interval,” “third mobile station route distance=second mobile station route distance+mobile station arrangement interval,” and the like.

In the case of evenly arranging mobile stations 10 at specific locations on the mobile station travel route, the processor 140 may set a route distance at which the first mobile station will be placed within a range not exceeding the mobile station arrangement interval and select as many route distances at which mobile stations will be arranged as the number of mobile stations to be arranged while adding the mobile station arrangement intervals to the route distance of the first mobile station.

For example, as shown in FIG. 15A, the processor 140 may evenly divide the total route distance into five segments which correspond to the number of mobile stations to be arranged. Subsequently, the processor 140 may place a mobile station at a random location on an evenly divided first travel route as shown in FIG. 15B. Subsequently, the processor 140 may arrange other mobile stations at the mobile station arrangement intervals from the first placed mobile station as shown in FIG. 15C.

According to the present invention, coordinates of a start point, an end point, and multiple bending points are input to set a mobile station travel route. Accordingly, it is possible to implement various shapes of routes that can be encountered in actual operational environments, all similar to actual mobile station routes in a simulation.

According to the present invention, random distribution and equal distribution are provided as mobile station arrangement types, and a mobile station range managed by a base station can be set as a one-way route or a roundtrip route. Accordingly, it is possible to model non-terrestrial communication system environments with routes of any shapes.

According to the present invention, the number of mobile stations that may be located on a mobile station route can be selected randomly within a specific range (e.g., 3 to 7 mobile stations may be randomly selected), or a specific number of mobile stations can be selected, which enables modeling of traffic environments corresponding to a variety of cases.

The present invention proposes a scheme for designing and implementing a non-terrestrial wireless communication system model that can provide a scheme for setting a flexible mobile station route (a start point, bending points, and an end point) that is applicable to MC simulations, a scheme for setting mobile station arrangement types (random and equal), a scheme for setting a base station management range (a one-way route or a roundtrip route), and a scheme for setting various traffic environments, thus supporting setting of an optimal base station location and a travel route, which contributes to solving traffic congestion in metropolitan areas and vitalizing new services.

The term “unit” used in this specification may include a unit implemented as hardware, software, or firmware and may be interchangeably used with terms such as “logic,” “logic block,” “part,” “circuitry,” or the like. A unit may be a single integral part or a minimum unit or part thereof. For example, according to an embodiment, a unit may be implemented in the form of an ASIC.

Description herein may be implemented as, for example, a method or process, a device, a software program, a data stream, or a signal. Although features are discussed only in the context of a single form of implementation (e.g., discussed only as a method), the discussed features may also be implemented in other forms (e.g., a device or program). The device may be implemented in appropriate hardware, software, firmware, or the like. The method may be implemented in a device such as a processor which generally refers to a processing device including, for example, a computer, a microprocessor, an integrated circuit, a programmable logic device, and the like. The processor also includes a communication device such as a computer, a cellular phone, a portable/personal digital assistant (PDA), and other devices that facilitate communication of information between end users.

Although the present invention has been described above with reference to limited embodiments and drawings, the present invention is not limited thereto. It would be appreciated by those skilled in the art that various modifications and alterations can be made without departing from the technical spirit of the present invention and equivalents to the following claims.

What is claimed is:

1. A method of generating a non-terrestrial communication system model, the method comprising:
setting, by a processor, reference coordinates and a management range of a base station;
receiving, by the processor, coordinates of at least one point among a start point, at least one bending point, and an end point of a route and setting a mobile station travel route in accordance with the management range of the base station;
determining, by the processor, route distances of mobile stations which will be arranged on the mobile station travel route on the basis of a mobile station arrangement type and a number of mobile stations to be arranged; and
calculating, by the processor, arrangement coordinates of the mobile stations.

2. The method of claim 1, wherein the management range of the base station is one of a one-way route and a roundtrip route.

3. The method of claim 1, wherein the setting of the mobile station travel route comprises acquiring, by the processor, new coordinates between the points on the mobile station travel route, calculating a cumulative route distance using the coordinates on the mobile station travel route, and calculating a total route distance from the start point to the end point using the cumulative route distance.

4. The method of claim 3, wherein the setting of the mobile station travel route comprises acquiring, by the processor, the new coordinates between the points on the mobile station travel route using at least one of interpolation and a coordinate setting technique.

5. The method of claim 1, wherein the determining of the route distances of the mobile stations which will be arranged comprises receiving, by the processor, the mobile station arrangement type and the number of mobile stations to be arranged from a user.

6. The method of claim 5, wherein the determining of the route distances of the mobile stations which will be arranged comprises, when the mobile station arrangement type is random, randomly selecting, by the processor, as many route distances at which the mobile stations will be arranged as the number of mobile stations to be arranged within a range not exceeding a total route distance of the mobile station travel route.

7. The method of claim 5, wherein the determining of the route distances of the mobile stations which will be arranged comprises, when the mobile station arrangement type is equal, calculating, by the processor, a mobile station arrangement interval using the total route distance of the mobile station travel route and the number of mobile stations to be arranged, evenly dividing the mobile station travel route at the mobile station arrangement intervals, setting a route distance at which a first mobile station will be placed within a range not exceeding the mobile station arrangement interval, and selecting as many route distances at which the mobile stations will be arranged as the number of mobile stations to be arranged while adding the mobile station arrangement intervals to the route distance of the first mobile station.

8. The method of claim 1, wherein the calculating of the arrangement coordinates of the mobile stations comprises calculating, by the processor, the arrangement coordinates of the mobile stations using route distances of the mobile stations which will be arranged on the mobile station travel route.

9. A device for generating a non-terrestrial communication system model, the device comprising:
a memory;
an input module; and
a processor connected to the memory and the input module,
wherein the processor receives coordinates of at least one point among a start point, at least one bending point, and an end point of a route through the input module, sets a mobile station travel route in accordance with a management range of a base station, determines route distances of mobile stations which will be arranged on the mobile station travel route on the basis of a mobile station arrangement type and a number of mobile stations to be arranged, and calculates arrangement coordinates of the mobile stations to generate a non-terrestrial communication system model.

10. The device of claim 9, wherein the processor sets reference coordinates of the base station which is a reference point of the non-terrestrial communication system model.

11. The device of claim 9, wherein the management range of the base station is one of a one-way route and a roundtrip route.

12. The device of claim 9, wherein, when setting the mobile station travel route, the processor acquires new coordinates between the points on the mobile station travel route, calculates a cumulative route distance using the coordinates on the mobile station travel route, and calculates a total route distance from the start point to the end point using the cumulative route distance.

13. The device of claim 12, wherein the processor acquires the new coordinates between the points on the mobile station travel route using at least one of interpolation and a coordinate setting technique.

14. The device of claim 9, wherein the processor receives the mobile station arrangement type and the number of mobile stations to be arranged from a user through the input module.

15. The device of claim 14, wherein, when the mobile station arrangement type is random, the processor randomly selects as many route distances at which the mobile stations will be arranged as the number of mobile stations to be arranged within a range not exceeding a total route distance of the mobile station travel route.

16. The device of claim 14, wherein, when the mobile station arrangement type is equal, the processor calculates a mobile station arrangement interval using the total route distance of the mobile station travel route and the number of mobile stations to be arranged, evenly divides the mobile station travel route at the mobile station arrangement intervals, sets a route distance at which a first mobile station will be placed within a range not exceeding the mobile station arrangement interval, and selects as many route distances at which the mobile stations will be arranged as the number of mobile stations to be arranged while adding the mobile station arrangement intervals to the route distance of the first mobile station.

17. The device of claim 9, wherein the processor calculates the arrangement coordinates of the mobile stations using route distances of the mobile stations which will be arranged on the mobile station travel route.
